(19) United States
(12) Patent Application Publication
(10) Pub. No.: US 2012/0325793 A1
(43) Pub. Date: Dec. 27, 2012

(54) Heating Accessory For Motor Vehicle

(76) Inventor: Michael Waters, Oak Ridge, TN (US)

(21) Appl. No.: 13/534,679

(22) Filed: Jun. 27, 2012

Related U.S. Application Data
(60) Provisional application No. 61/501,356, filed on Jun. 27, 2011.

(51) Int. Cl. B60H 1/22

(52) U.S. Cl. 219/202

(57) ABSTRACT

A heating accessory system for a vehicle comprising: a heating unit, where said heating unit is placed in a duct of an existing heating system; a power inverter/transformer, where the power inverter/transformer supplies power to the heating unit; and a power source, where the power source sends power to the power inverter/transformer. The heating unit may include a series of wired coils wrapped with insulating materials.

### CROSS REFERENCE TO OTHER APPLICATIONS

This application claims priority to U.S. Provisional Application Ser. No. 61/501,356 filed on Jun. 27, 2011.

### BACKGROUND OF THE INVENTION

1. Field of Invention

The present invention relates to a heating accessory that enables for the accelerated heating of a motor vehicle.

2. Description of Related Art

Most vehicles include both heating and cooling systems to control the interior environment of the vehicle. Air conditioning is handled through forced air through an air conditioner's evaporator coil and as cold gas is released within the coil to create the cooling effect of the air conditioning system. Similarly, a heater core is utilized to generate heat within the interior of the vehicle. The heating core is a radiator type device, where hot coolant from the vehicle's engine is passed through a winding tube core and thus creates a heat exchanger between the coolant and the cabin air. As the engine's coolant heats up the mixture provides sufficient heat that may be diverted into the interior of the vehicle. A fan is utilized within the ventilation system that forces air around the heater core and this heat is then transferred into the vehicle to warm the vehicle during cool temperatures.

One disadvantage to the traditional vehicle heating system is that because coolant is used to provide the source of the heat, the engine must operate a period of time to warm the coolant to a sufficient temperature in order to provide sufficient heat through the heater core. Many times individuals are prepared to operate the vehicle immediately upon entry and therefore it may be desired to receive heat as soon as possible upon entry into the vehicle.

### SUMMARY OF THE INVENTION

The present invention relates to a heating accessory system for a vehicle comprising: a heating unit, where said heating unit is placed in a duct of an existing heating system; a power inverter/transformer, where the power inverter/transformer supplies power to the heating unit; and a power source, where the power source sends power to the power inverter/transformer. The heating unit may include a series of wired coils wrapped with insulating materials.

The present invention also includes a method of rapidly heating a vehicle comprising the steps of: placing a heating unit in at least one duct of a ventilation system of the vehicle; transmitting an charge to the heating unit, where the charge travels through a power inverter transformer from a power source; initiating a blower within the ventilation system, where the blower enables the transfer of air through the heating unit; monitoring temperature within a heating core of the vehicle; and extinguishing use of the heating unit at a predetermined temperature of the heating core.

### BRIEF DESCRIPTION OF DRAWINGS

FIG. 1 depicts a heating accessory according to the present invention that may be implemented to provide accelerated heat in a vehicle.

### DETAILED DESCRIPTION

The present invention relates to a heating unit that is installed within the air duct of a conventional vehicle heating duct. The heating unit according to the present invention provides instantaneous heat based upon electrical heating coils within the heating unit. The heating unit is electrically controlled through a power inverter and transformer. Energy is supplied by the battery of the vehicle and temperature is controlled via a control mechanism within the interior of the vehicle.

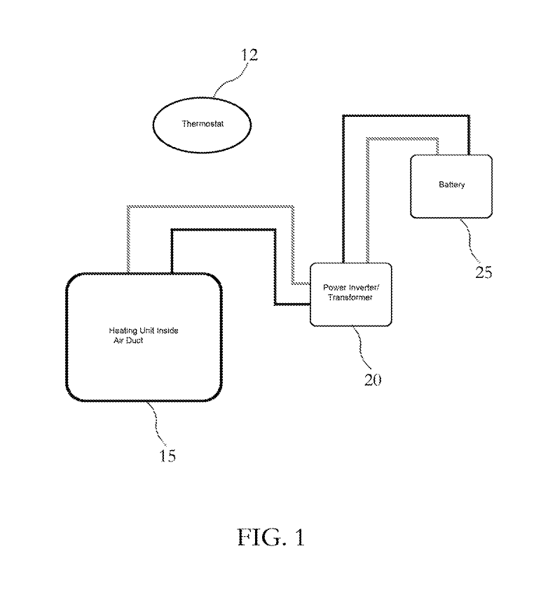

FIG. 1 depicts an overview of the heating system accessory according to the present invention. The present invention includes a heating unit 15 that is placed within the air duct of the ventilation system within the vehicle. The heating unit 15 consists of a series of wired coils wrapped with insulating materials that receive electricity through the vehicle's power system, which is typically a battery. The coils heat rapidly through the electrical charge received through the battery system of the vehicle. A power inverter transformer 20 connects the heating unit 15 to a battery at 25 as shown in FIG. 1. These three components make up the essential components of the present invention. The power inverter and transformer 20 provide a rapid surge of electricity to provide sufficient power to heat the coils as sufficient temperature. A blower within the ventilation system then transfers the heat generated by the coils into the interior of the motor vehicle. A thermostat 12 is also provided that works in conjunction with this heating system. The thermostat 12 is used to set the temperature of the heating unit 15. Further the thermostat 12 provides a means to extinguish the use of the heating unit 15 upon receipt of sufficient heat provided by the vehicle's heating core. Once the heating core of the vehicle reaches a preset temperature sufficient heat may be provided into the vehicle. Once the heating core of the vehicle has reached this preset temperature, the heating unit 15 extinguishes or shuts off and therefore the vehicle is heated through the conventional heating core system as described above.

The accessory heating system according to the present invention utilizes sufficient power wattage enabled by the power inverter and transformers. This heating system allows for quick accelerated heating of the coils within in the heating unit 15 and therefore instantaneous heat provided for the vehicle's interior cabin. The present invention is particularly helpful in extreme frigid conditions where heat is desired as quick as possible. The present invention allows the user to enjoy some heat until the heating core of the vehicle is sufficiently hot to supply heat to the interior. The instant invention has been shown and described in what it considers to be the most practical and preferred embodiments. It is recognized, however, that departures may be made there from within the scope of the invention and that obvious modifications will occur to a person skilled in the art.

What is claimed is:

1. A heating accessory system for a vehicle comprising:
a. a heating unit, where said heating unit is placed in a duct of an existing heating system;
b. a power inverter/transformer, where the power inverter/transformer supplies power to the heating unit; and
c. a power source, where the power source sends power to the power inverter/transformer.

2. The heating accessory system according to claim 1, where said heating unit includes a series of wired coils wrapped with insulating materials.

3. A method of rapidly heating a vehicle comprising the steps of:
a. placing a heating unit in at least one duct of a ventilation system of the vehicle;
b. transmitting an charge to the heating unit, where the charge travels through a power inverter transformer from a power source;
c. initiating a blower within the ventilation system, where the blower enables the transfer of air through the heating unit;
d. monitoring temperature within a heating core of the vehicle; and
e. extinguishing use of the heating unit at a predetermined temperature of the heating core.

4. The method according to claim 3, where the heating unit includes a series of wired coils.

5. The method according to claim 4, further including the step of wrapping the series of wired coils with insulating materials.
